(19) United States
(12) Patent Application Publication
(10) Pub. No.: US 2013/0016895 A1
(43) Pub. Date: Jan. 17, 2013

(54) METHOD AND SYSTEM FOR DEFECT-BITMAP-FAIL PATTERNS MATCHING ANALYSIS INCLUDING PERIPHERAL DEFECTS

(71) Applicants: Zhigang Song, Hopewell Junction, NY (US); Xu Ouyang, Hopewell Junction, NY (US); Yunsheng Song, Hopewell Junction, NY (US)

(72) Inventors: Zhigang Song, Hopewell Junction, NY (US); Xu Ouyang, Hopewell Junction, NY (US); Yunsheng Song, Hopewell Junction, NY (US)

(73) Assignee: INTERNATIONAL BUSINESS MACHINES CORPORATION, Armonk, NY (US)

(21) Appl. No.: 13/183,899

(22) Filed: Jul. 15, 2011

(51) Int. Cl. G06K 9/00

(52) U.S. Cl. 382/149

(57) ABSTRACT

A system and method for fail pattern analysis for a memory device is disclosed. The peripheral circuits of a memory device are divided into different zones based on circuit design and layout. Defects are detected by inline inspection of multiple SRAM devices at various stages in the manufacturing process and saved into a database. When the devices are fabricated, electrical tests are then performed. Electrical failure patterns are also recorded and saved in the database. A correlation between the zone in which a visual defect resides and an electrical failure is recorded in computer storage. Visual defects found during inline inspection are then associated with an electrical failure in the memory device.

### FIELD OF THE INVENTION

The present invention relates generally to semiconductor manufacturing yield analysis, and more particularly to inline inspection, testing, and defect analysis of semiconductor memory arrays.

### BACKGROUND OF THE INVENTION

One of the main methods of improving circuit yield during the development or manufacturing of integrated circuits is to study the fail patterns uncovered by a tester used to test a given integrated circuit. If the defects for these fail patterns were identified and the nature of the defects were understood, corrective actions could then be taken to improve the yield, based on the knowledge of such defects gained from such analysis, either from the process side or the design side.

Existing methods for analyzing semiconductor fail patterns are developed from the memory bitmap fail patterns in memory arrays. Unlike logic circuits, memory chips can easily provide the exact X, Y coordinates of each memory cell. Therefore, memory chips have been used more extensively in fail pattern analysis than logic circuits. However, memory devices comprise other circuits beyond the memory arrays used for data storage. Multiple peripheral circuits exist for addressing, accessing, and supplying power to the memory arrays. It is therefore desirable to have a method and system for defect-bitmap-fail pattern analysis that considers defects in these peripheral circuits.

### SUMMARY

In one embodiment of the present invention, a method for associating an electrical failure with a visual defect in a memory device is provided. The memory device comprises a memory array and peripheral circuits. The method comprises dividing the peripheral circuits into a plurality of zones, determining an electrical fail pattern corresponding to each zone of the plurality of zones, and recording each zone and the corresponding electrical fail pattern in a database.

In another embodiment of the present invention, a method for fail pattern analysis for a memory device is provided. The memory device comprises a memory array and peripheral circuits. The method comprises identifying a visual defect in the peripheral circuits, determining a visual defect location for the visual defect, determining a corresponding zone that includes the visual defect location, and identifying an electrical fail pattern having a correlation to the corresponding zone. In another embodiment, a system for fail pattern analysis for a memory device is provided. The memory device comprises a memory array and peripheral circuits. The system comprises a computer. The computer comprises a processor, non-transitory storage embodied in a computer-readable medium, a communications interface, and a database. The system further comprises a network, an inline inspection tool, and an electrical test tool. The computer communicates with the inline inspection tool and electrical test tool via the communications interface using the network, and wherein the non-transitory storage contains machine instructions, that when executed by the processor, perform the function of retrieving a visual defect from the inline inspection tool; determining a visual defect location for the visual defect; determining a corresponding zone that includes the visual defect location; predicting an electrical fail pattern having a correlation to said corresponding zone; and comparing the predicted electrical fail pattern to an electrical test fail pattern.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG).

FIG. 1 shows an overview of an SRAM device indicating various zones.

FIG. 2 is an example detail of a zone with a defect and corresponding fail pattern.

FIG. 3 is an example detail of another zone with a defect and corresponding fail pattern.

FIG. 4A.-FIG. 4D are examples of database structures used in accordance with an embodiment of the present invention.

FIG. 5A is a flowchart indicating process steps for a lookup table creation process for an embodiment of the present invention.

FIG. 5B is a flowchart indicating process steps for an analysis process for an embodiment of the present invention.

FIG. 6 is a block diagram of a system in accordance with an embodiment of the present invention.

FIG. 7 is an example of a graphical representation comprising a report in accordance with an embodiment of the present invention.

### DETAILED DESCRIPTION

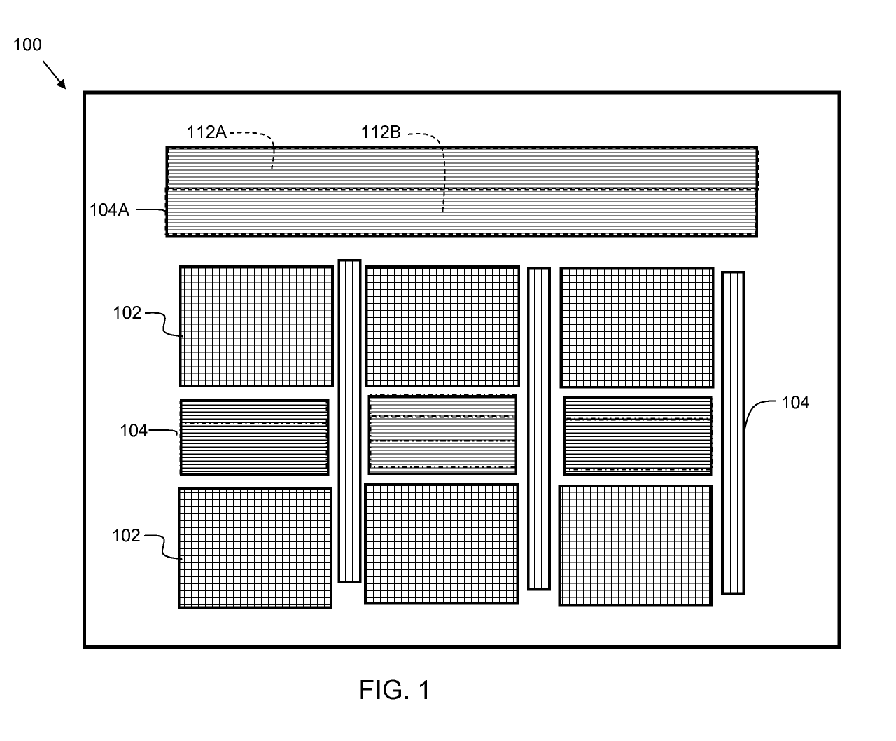

FIG. 1 shows an overview of an SRAM device 100 indicating various memory arrays 102, and various peripheral circuits, indicated generally as 104. Peripheral circuits 104 comprise supporting logic and power circuits, and may include, but are not limited to, power supply circuits, local bit line control signals, global bit line control signals, and word line control signals. The peripheral circuits 104 can be logically divided into different zones based on circuit design and layout. For example, the peripheral circuit 104A can be further divided into two zones as indicated (112A and 112B). The defects detected by inline inspection (comprising an optical inspection, or an electron beam scan tool such as a SEM or other “e-beam” tool) may fall into the SRAM array or into one of the different zones of the peripheral circuits, causing different electrical fail patterns. Hence, as used in this disclosure, the term “inline defect” or “visual defect” refers to a defect detectable by a tool such as a SEM or optical inspection tools. A particular inline defect in a memory array 102 has a high correlation to a particular electrical failure pattern at the same location, because the physical arrangement of the memory cells in the array is generally contiguous. However, such point to point correlation is generally not applicable to peripheral circuits 104.

Embodiments of the present invention comprise a lookup table (database) creation process and a defect-bitmap fail pattern matching analysis process. The lookup table (database) creation process comprises dividing the peripheral circuits into different zones based on circuit design and layout and listing the suspected failure patterns with a defect in particular zones at various layers. The defects are detected by inline inspection of multiple SRAM devices at various stages in the manufacturing process and saved into a database. When the devices are fabricated, electrical tests are then performed. Electrical failure patterns are also recorded and saved in the database.

Once the lookup table has been created, and inline defects and electrical failure patterns are recorded, the defect-bitmap-fail-pattern matching analysis can be performed. For an inline (visual) defect, if the defect is located within peripheral circuits, the corresponding zone will be identified. Based on the lookup table, a suspected failure pattern (bitmap-fail-pattern) is predicted. Then the predicted bitmap-fail-pattern is compared with the actual electrical test bitmap-fail-pattern at the corresponding location. If the predicted and actual bitmap-fail-patterns match, the inline defect is a so called “killer defect” that causes the electrical failure. Reiterating the defect-bitmap-fail-pattern matching analysis process for all inline defects, a graphical representation, such as a Pareto chart, for all electrical test bitmap-fail-patterns can be obtained.

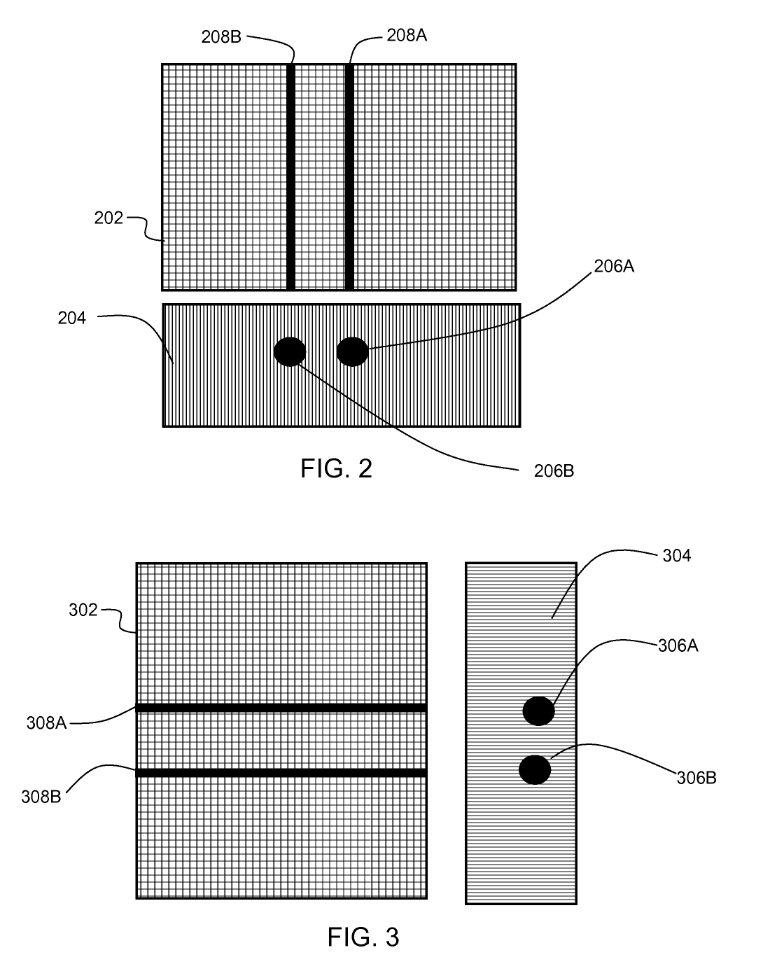

FIG. 2 is an example detail of a visual defect in a zone associated with a bitmap-fail-pattern, namely a defect 206A in peripheral circuit 204 corresponds to an electrical failure 208A in array 202. This bitmap-fail-pattern is a local bit line failure. It is also noted that the defects in different locations in the same zone will cause the same bitmap-fail-pattern, but at different locations, like defect 206A corresponds to local bit line failure 208A, while defect 206B corresponds to local bit line failure 208B.

FIG. 3 is an example detail of a defect in another zone associated with another bitmap-fail-pattern, namely a defect 306A in peripheral circuit 304 corresponds to an electrical failure 308A in array 302. This bitmap-fail-pattern is a local word line failure. It is also noted that the defects in different locations in the same zone will cause the same bitmap-fail-pattern, but at different locations, like defect 306A corresponds to local word line failure 308A, while defect 306B corresponds to local word line failure 308B. Note that FIG. 2 and FIG. 3 show examples of defects in different zones corresponding to different bitmap-fail patterns. While the examples mentioned bit line and word line failures, embodiments of the present invention are not limited to those types of failures, and may be applied to any electrical failure that matches with any inline defect.

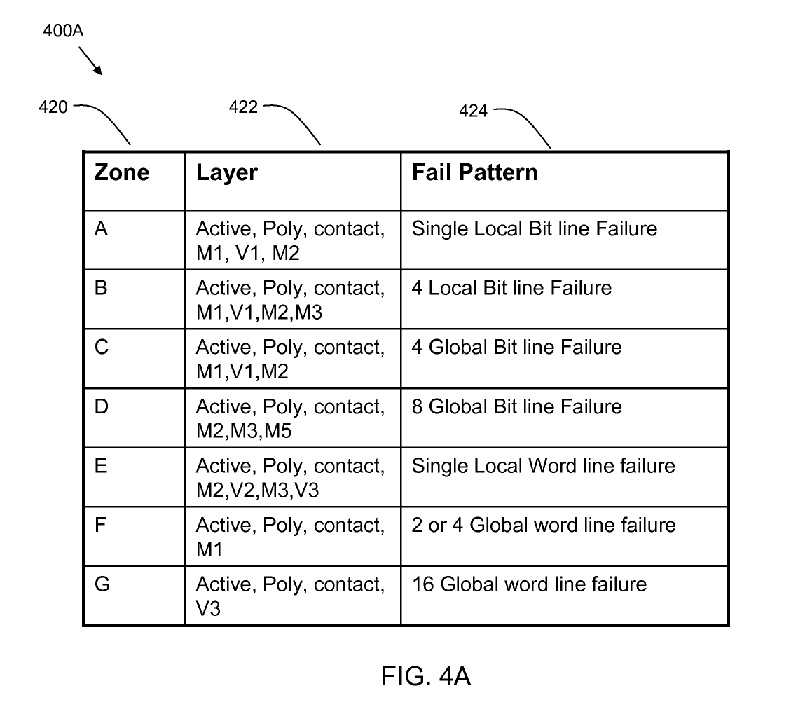

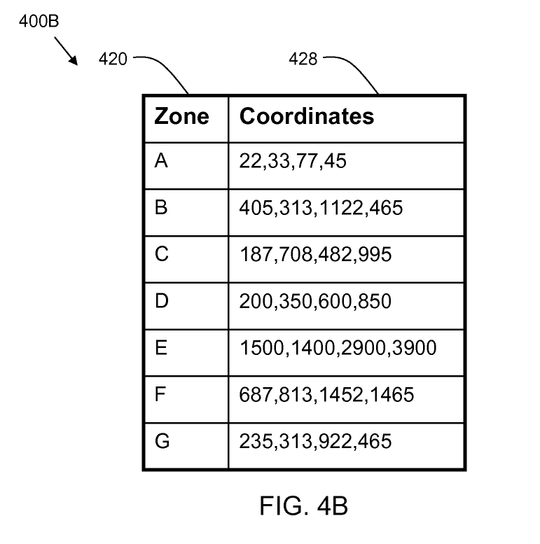

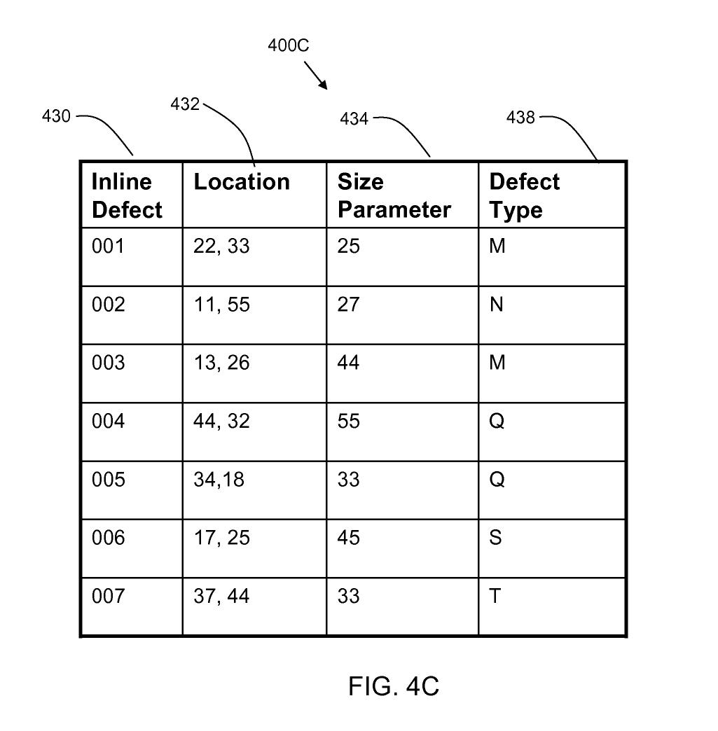

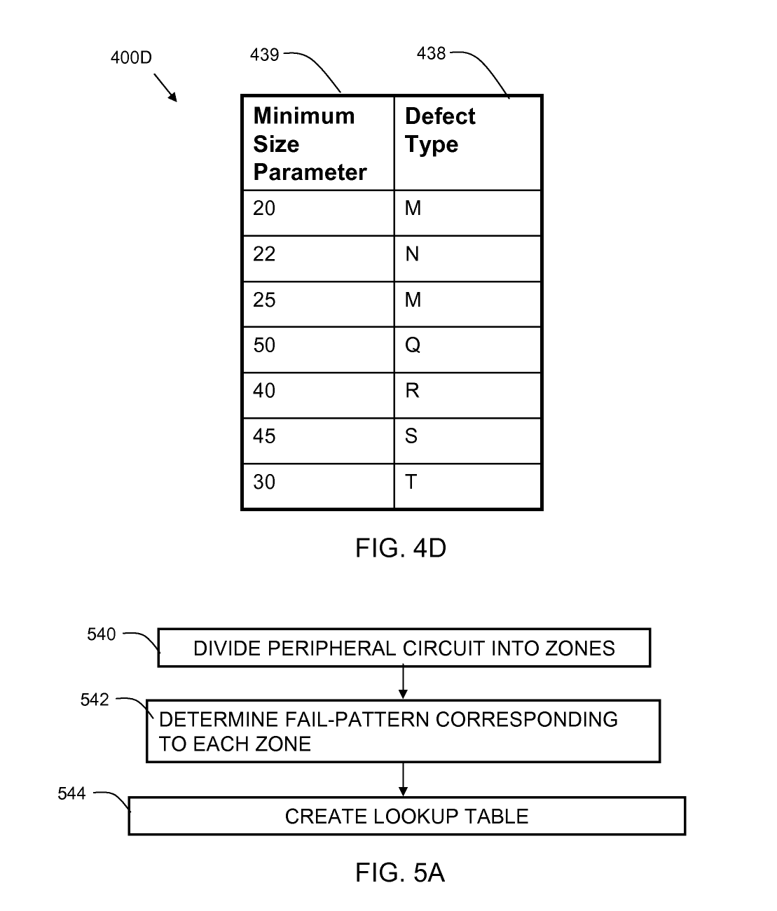

FIG. 4A and FIG. 4B are examples of lookup tables used in accordance with an embodiment of the present invention. In FIG. 4A, three fields are shown in table 400A. Field 420 is the peripheral circuit zone. Each zone may be denoted by an alphanumeric code. In this case, the zones are denoted by letters ranging from A-G. Each zone may then be associated with the physical coordinates that defines them. For example, each zone may be defined by two X-Y coordinate sets, where the first X-Y coordinate set represents the bottom left corner of the zone, and the second X-Y coordinate set represents the upper right corner of the zone. This is shown in FIG. 4B, with table 400B comprising field 428 representing the X-Y coordinate pairs for each zone. When a visual defect is found, the visual defect location is identified by (e.g. X-Y) coordinates, and a check is then made to see which zone that visual defect location falls within.

Field 422 is the layer list, indicating the layer(s) where the inline defect is detected. The layers listed here in each zone for the corresponding fail pattern are just examples. The layers may change depending on the design of a particular device. For example, M1 may refer to metal layer #1 and V1 may refer to via level 1. Field 424 is the corresponding bitmap-fail pattern. In the example shown in FIG. 4A, the electrical fail patterns comprise: single local bit line failure, 4-local bit line failure, 4-global bit line failure, 8-global bit line failure; single local word line failure; 2 or 4-global word line failure, and 16-global word line failure. Other electrical fail patterns may also be included within field 424.

FIG. 4C shows an optional data structure 400C used for an additional embodiment of the present invention. Field 430 shows a list of inline defects found during an inline inspection. For each defect, its location is identified by X-Y coordinates in field 432, used to determine the zone that the defect belongs to. A size parameter for each inline defect is recorded in field 434 and a defect type is recorded in field 438. The size parameter may be an actual dimension (e.g. the width, length, or area) of the defect (e.g. in nanometers). This information may be used to fine-tune the matching analysis process by determining the minimum defect size which can cause a failure in a particular technology. For example, when inline defects with a size parameter below a particular value do not cause a fail, then in a future matching analysis process, inline defects with a size parameter below a predetermined threshold may be ignored. The defect type may be used in reports to provide valuable information to process engineers. Each letter in the defect type field 438 represents a different type of defect. For example, in one embodiment, M is a missing contact (contact area), N is a contact-poly short, P is an open line, etc . . . . This allows the contribution of each defect type to each of the various electrical failures to be identified. It is also noted that different defects, even in different zones and causing different fail patterns, may be of the same defect type. For example, inline defects 001 and 003 belong to the same defect type M.

FIG. 4D shows an optional data structure 400D, which shows a relationship between minimum size parameter 439 and defect type 438. Each defect type has an associated minimum size parameter. The minimum size parameter may be used to further fine-tune the analysis. For example, in FIG. 4D, the minimum size parameter for defect type Q is 50. Therefore, in FIG. 4C, inline defect 004 is of defect type Q and has a size parameter of 55, which exceeds the minimum size parameter of 50, and thus, would be considered as indicative of an electrical failure. Conversely, defect 005 is of defect type Q and has a size parameter of 33, which is less than the minimum size parameter of 50, and hence, would not be considered as indicative of an electrical failure.

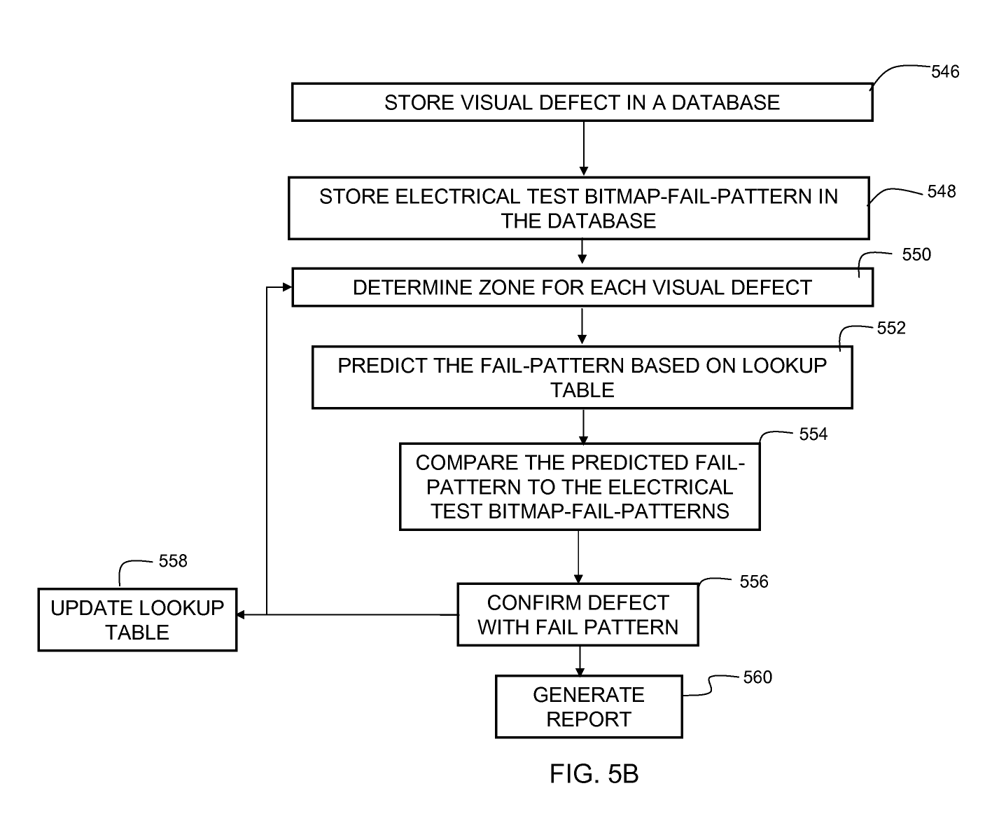

FIG. 5A is a flowchart indicating process steps for lookup table creation process for an embodiment of the present invention. In process step 540, the peripheral circuits are divided into multiple zones. In process step 542, fail-patterns are determined based on circuit design and layout, corresponding to each zone. For example, based on the design, it may be that a defect in a particular zone results in a single local word line failure.

In process step 544, the lookup table (in general, this may be implemented via a database, and the term “database” refers to a data store comprising one or more tables, and may comprise a relational database) is created for defect-bitmap-failure matching analysis. The devices for which visual defects have been identified in peripheral zones and bitmap-fail-patterns have been obtained by electrical test are then ready for defect-bitmap-fail-pattern matching analysis.

FIG. 5B is a flowchart indicating process steps for the defect-bitmap-fail-pattern matching analysis process for an embodiment of the present invention. In process step 546, inline (visual) defects are detected by inline inspection and stored in a database. Note that a “visual” defect for the purposes of this disclosure may include defects detected with a non-optical inspection technique, such as that performed with a SEM or other e-beam tool. This process step may be performed inline at various stages in the fabrication process.

In process step 548, an electrical test is performed on the inline inspected wafer after it is fabricated, and the bitmap-fail-patterns are saved in the same database as the visual (inline) defects. In process step 550, for each visual (inline) defect found, a peripheral circuit zone is identified. In process step 552, a corresponding fail-pattern is predicted based on the lookup table that was created by process steps 540-544 of FIG. 5A. For example (based on the data shown in FIG. 4A), given a visual defect found in zone A, the predicted fail-pattern is a single local bit line failure.

In process step 554, the predicted fail pattern from process step 552 is compared to the electrical test fail pattern from process step 548.

In process step 556, if the predicted fail pattern and the electrical test bitmap-fail pattern match, the visual defect is confirmed to be the root cause of the electrical bitmap-fail-pattern. The process steps 550-556 are reiterated until all defects are analyzed. In step 558, the lookup table can be updated with inline defects in new zones corresponding with new electrical test bitmap-fail-patterns. For example, when an electrical failure is found during test of a wafer, and that electrical failure is not currently in the lookup table, a comparison of inline defect data for that failure can be performed to see if there is an inline defect in a peripheral zone. If so, that information is then added to the lookup table, such that during a future matching analysis, a similar inline defect will be treated as indicative of an electrical failure.

Finally, a report may be generated in process step 560 to present the defect-bitmap-fail-pattern analysis results. In one embodiment, the report generated in step 560 includes a graphical representation indicating the defects for various bitmap-fail-patterns

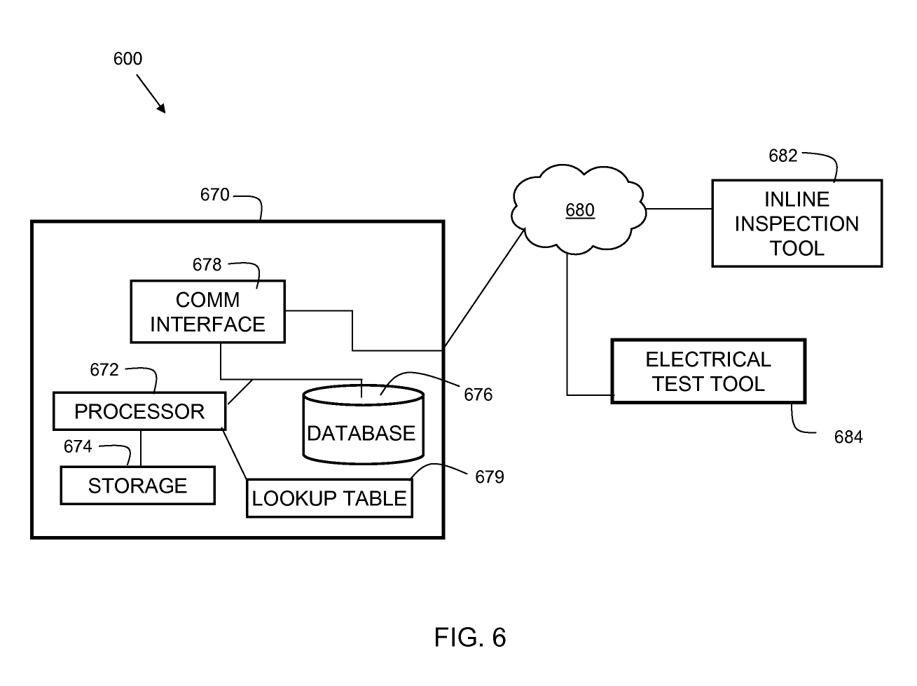

FIG. 6 is a block diagram of a system 600 in accordance with an embodiment of the present invention. System 600 comprises computer 670 which communicates with inline inspection tool 682 and electrical test tool 684 via communications interface 678, which is connected to communications network 680. In one embodiment, communications network 680 may comprise an Ethernet network. Computer 670 comprises a processor 672 and non-transitory storage 674, which is a computer-readable medium such as read-only memory (ROM). Database 676 may reside on one or more magnetic disks, or in other non-volatile storage. Lookup table 679 may be saved in non-volatile memory (e.g. a hard disk) of the computer 670. Lookup table 679 may also be implemented via a database. Non-transitory storage 674 contains machine instructions. When these machine instructions are executed by processor 672 of computer 670, the system 600 implements the processes described in FIG. 5A and FIG. 5B. The inline inspection tool 682 may comprise a scanning electron microscope (SEM), optical inspection tools, or other e-beam inspection tool, and the electrical test tool 684 may be any SRAM tester. The computer 670 communicates with inline inspection tool 682 via communications network 680 to retrieve defects and determine the corresponding zones for these defects. The computer 670 also retrieves the electrical test fail patterns from the electrical test tool 684 via communications network 680 for the wafers that previously underwent inline inspection.

All the inline defect and electrical test bitmap-fail-pattern information are saved in database 676. The computer 670 predicts an electrical fail pattern for every one of the visual defects with zone information through lookup table 679 and compares the predicted fail pattern to the electrical test (bitmap) fail pattern for a given device. The above-mentioned defect-bitmap-fail-pattern matching analysis process is reiterated until all defects are analyzed. The analysis results are saved in storage 674.

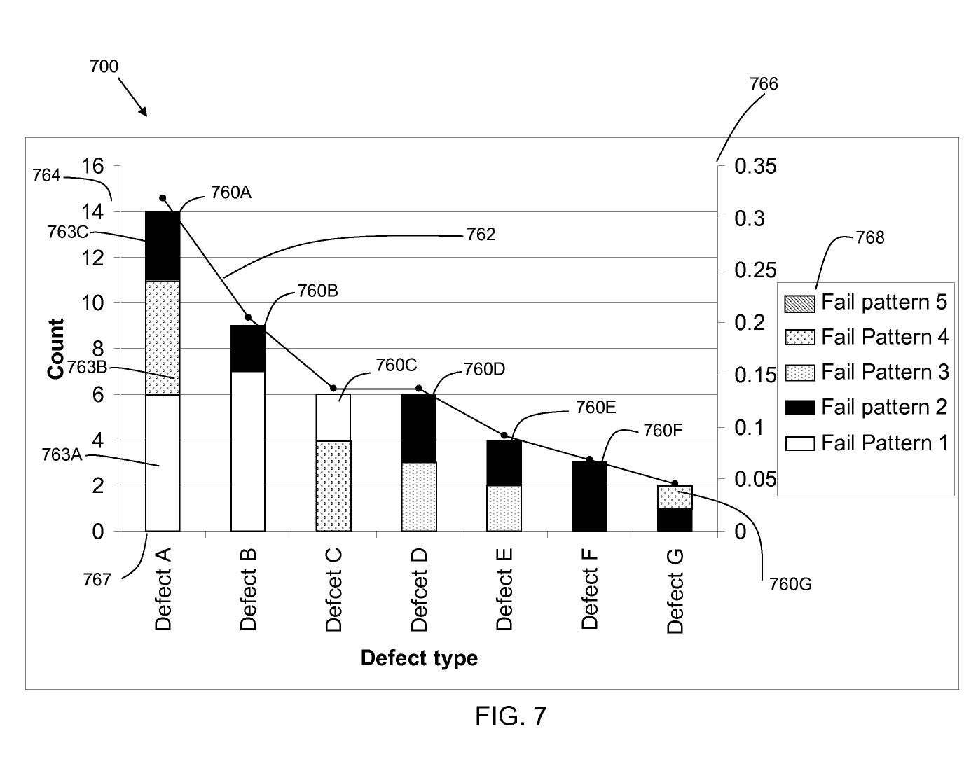

FIG. 7 is an example of a graphical representation 700 comprising a report in accordance with an embodiment of the present invention. Graphic representation 700 comprises a plurality of bar indicators (760A-760G) that each corresponds to an inline killer defect. Each bar breaks down to several portions, with each portion representing the bitmap-fail-patterns, as showed in legend 768, caused by the inline killer defect. Each portion of the bar represents the number of each bitmap-fail-pattern caused by the inline killer defect. The left vertical axis 764 represents the total number of each inline killer defect found during an inspection cycle. Optionally, line 762 may be rendered to show the percentage of each inline killer defect as read by the right vertical axis 766, which is the percent contribution of the particular defect (A-G) towards the total number of defects. Each defect type is represented on the bottom axis 767. The defects (A-G) may be sorted in descending order on bottom axis 767 such that the defect causing the most failures is shown first on graphical representation 700. In this example, defect A is causing the most electrical failures. Furthermore, each bar indicator may be rendered with multiple bar sections (763A-763C) to indicate failure type. For example, bar indicator 760A comprises three bar sections (763A-763C) to represent the number of occurrences of each fail pattern caused by a particular defect type. In the case of bar indicator 760A, section 763A corresponds to fail pattern 1, section 763B corresponds to fail pattern 4, and section 763C corresponds to fail pattern 2. Using the information in graphical representation 700, a process engineer can determine which inline killer defects should receive the most attention for elimination by modification of process (“recipe”) parameters.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for associating an electrical failure with a visual defect in a memory device, the memory device comprising a memory array and peripheral circuits, the method comprising:
dividing the peripheral circuits into a plurality of zones;
determining an electrical fail pattern corresponding to each zone of the plurality of zones; and
recording each zone and the corresponding electrical fail pattern in a database.

2. The method of claim 1, further comprising establishing a defect type for the visual defect.

3. The method of claim 2, further comprising establishing a minimum size parameter for the defect type.

4. The method of claim 1, wherein each zone is stored in the database as a set of X-Y coordinate pairs.

5. The method of claim 1, wherein determining an electrical fail-pattern corresponding to each zone of the plurality of zones comprises identifying electrical failures selected from the group consisting of: single local bit line failure, single local word line failure, four local bit line failure, four global bit line failure, eight global bit line failure, and sixteen global word line failure.

6. A method for fail pattern analysis for a memory device, the memory device comprising a memory array and peripheral circuits, the method comprising:
identifying a visual defect in the peripheral circuits;
determining a visual defect location for the visual defect;
determining a corresponding zone that includes the visual defect location; and
identifying an electrical fail pattern having a correlation to the corresponding zone.

7. The method of claim 6, wherein identifying an electrical failure having a correlation to the corresponding zone comprises:
identifying a defect type for the visual defect;
retrieving from a database a minimum size parameter for the defect type;
retrieving a size parameter for the visual defect from the database; and
predicting an electrical fail pattern if the size parameter for the visual defect is greater than the minimum size parameter for the defect type.

8. The method of claim 6, wherein retrieving a size parameter for the visual defect comprises retrieving the length and width of the visual defect.

9. The method of claim 6, wherein retrieving a size parameter for the visual defect comprises retrieving the area of the visual defect.

10. The method of claim 7, wherein retrieving a size parameter for the visual defect comprises retrieving a size parameter in nanometers.

11. The method of claim 6, wherein identifying an electrical fail pattern having a correlation to the corresponding zone comprises identifying an electrical fail pattern selected from the group consisting of: single local bit line failure, single local word line failure, four local bit line failures, four global bit line failures, eight global bit line failures, and sixteen global word line failures.

12. The method of claim 7 further comprising:
comparing an electrical test fail pattern to the predicted electrical fail pattern having a correlation to the corresponding zone; and
updating the database based on the outcome of the comparison.

13. The method of claim 6, further comprising generating a report comprising a graphical representation comprising a bar graph comprising multiple bars, wherein each bar is a representation of the percentage of killer defects contributed by a defect type.

14. The method of claim 13, wherein each bar is divided into multiple sections, wherein each section represents the number of occurrences of each fail pattern caused by a defect type.

15. The method of claim 14, wherein the multiple bars are arranged in descending order.

16. A system for fail pattern analysis for a memory device, the memory device comprising a memory array and peripheral circuits, the system comprising:
a computer, said computer comprising a processor, non-transitory storage embodied in a computer-readable medium, a communications interface, and a database, a network;
an inline inspection tool; and
an electrical test tool;
wherein the computer communicates with the inline inspection tool and electrical test tool via the communications interface using the network, and wherein the non-transitory storage contains machine instructions, that when executed by the processor, perform the function of:
retrieving a visual defect from the inline inspection tool;
determining a visual defect location for the visual defect;
determining a corresponding zone that includes the visual defect location;
predicting an electrical fail pattern having a correlation to said corresponding zone; and
comparing the predicted electrical fail pattern to an electrical test fail pattern.

17. The system of claim 16, wherein the database stores associations of peripheral zones with electrical fail patterns selected from the group consisting of: single local bit line failure, single local word line failure, four local bit line failures, four global bit line failures, eight global bit line failures, and sixteen global word line failures.

18. The system of claim 16, wherein the non-transitory storage contains machine instructions, that when executed by the processor, perform the function of:
retrieving a size parameter for the visual defect from a database;
retrieving a minimum size parameter for the corresponding zone; and
predicting an electrical fail pattern if the size of the visual defect exceeds the minimum size parameter.

19. The system of claim 18, wherein the non-transitory storage contains machine instructions, that when executed by the processor, perform the function of:
confirming the visual defect by comparing the predicted fail pattern to the electrical test fail pattern; and
updating the database based on the outcome of the comparison.

20. The system of claim 18, wherein the non-transitory storage contains machine instructions, that when executed by the processor, perform the function of:
receiving a value for the minimum size parameter in nanometers.
